(19) United States
(12) Patent Application Publication
(10) Pub. No.: US 2013/0196884 A1
(43) Pub. Date: Aug. 1, 2013

(54) Downhole Chemical Delivery For Oil And Gas Wells

(71) Applicants: Sarkis Kakadjian, The Woodlands, TX (US); James Joseph Venditto, Houston, TX (US); Frank Zamora, San Antonio, TX (US); Ronald Joseph Powell, Humble, TX (US); Joseph E. Thompson, Houston, TX (US)

(72) Inventors: Sarkis Kakadjian, The Woodlands, TX (US); James Joseph Venditto, Houston, TX (US); Frank Zamora, San Antonio, TX (US); Ronald Joseph Powell, Humble, TX (US); Joseph E. Thompson, Houston, TX (US)

(73) Assignee: Trican Well Service, Ltd.

(21) Appl. No.: 13/364,156

(22) Filed: Feb. 1, 2012

(51) Int. Cl. C09K 8/80; B05D 1/36

(52) U.S. Cl. 507/203; 507/200; 507/269; 427/402

(57) ABSTRACT

A method of reducing the cost and environmental impact of chemicals used in hydraulic fracturing is to use a proppant that is coated with at least two chemicals, where each of those chemicals are useful in treating a well. By coating at least two chemicals onto the proppant the amounts of chemicals required to treat a well are reduced by delivering the chemicals to only the areas that require treatment. Additionally mixing issues are avoided as only a single proppant or substrate is used in the well.

### BACKGROUND

Hydraulic fracturing is a common and well-known enhancement method for stimulating the production of natural gas. The process involves injecting fluid down a wellbore at high pressure. The fracturing fluid is typically a mixture of water and proppant. The proppant may be made of natural materials or synthetic materials.

Generally the fracturing process includes pumping the fracturing fluid from the surface through a tubular. The tubular has been prepositioned in the wellbore to access the desired hydrocarbon formation. The tubular has been sealed both above and below the formation to isolate fluid flow either into or out of the desired formation and to prevent unwanted fluid loss. Pressure is then provided from the surface to the desired hydrocarbon formation in order to open a fissure or crack in the hydrocarbon formation.

Typically large amounts of fluid are required in a typical hydraulic fracturing operation. Additionally, chemicals are often added to the fluid along with proppant to aid in proppant transport, friction reduction, wettability, pH control and bacterial control. At the well site, the fluid is mixed with the appropriate chemicals and proppant particulates and then pumped down the wellbore and into the cracks or fissures in the hydrocarbon formation.

Previously some methods for delivering chemicals to a hydrocarbon formation include methods in which the chemical is formed into particles that are suspended in the fluid and are then pumped down a wellbore to the reservoir. The particulated chemicals may be formed by absorption into the pores of porous carrier particles and encapsulation as a core-shell structure in which a single quantity, the core, of the chemical is enclosed within a shell of carrier material. Another commonly known method is to treat a substrate so that the substrate, in some cases the proppant, becomes coated with a quantity of the desired chemical and then pumping the particulated chemical into the well.

After the well has been fractured and appropriately treated the fluid is allowed to flow back from the hydrocarbon formation to the wellbore and then to the surface

In many instances multiple chemicals may be necessary in identical locations within the hydrocarbon formation or within the wellbore. In those instances, without very thorough mixing of various particulated chemicals, the precise amount of chemical desired may not be appropriately distributed through the hydrocarbon formation. Even when the particulated chemicals are thoroughly mixed at the surface they may segregate out of the mixture during the long journey downhole. Due to the difficulties of assuring that the required quantities of each chemical reach the desired portions of the hydrocarbon formation overlarge quantities of each chemical may be utilized incurring both monetary and environmental costs. To reduce costs and minimize potential environmental issues there exists a significant need to reduce the total amount of chemicals that are pumped into a well and that may flow out of the well with produced fluids. Such results may be accomplished by coating a substrate, such as the proppant, with multiple coatings of chemicals, in the amounts and formulations desired, and thereby placing only as much of each chemical as required and only where they are required.

### SUMMARY

An embodiment of this invention provides a process for providing chemicals into a hydrocarbon formation by utilizing the fracturing process. Such a process includes pumping particles suspended within a fluid, where at least a portion of the particles are coated with at least two desired chemicals, into a hydrocarbon formation.

The particles suspended within the fluid that is pumped into the well bore may be a fluid that is distinct from the fracturing fluids, but in many instances it will be convenient for it to be a suspension of the particles in a quantity of fracturing fluid. Thus it is possible to coat chemicals onto a substrate, deliver a high proportion of the chemicals into a hydrocarbon formation, and then release the chemicals where they are required.

A range of chemicals may be coated onto a substrate and carried into a hydrocarbon formation during fracturing. Such chemicals include friction reducers, gelling agents, clay control systems, biocides, scale, inhibitors, chelating agent, gel breaker, antifoamers, crosslinker, wax inhibitor, a corrosion inhibitor, de-emulsifier, foaming agent, surfactants, agglomerating agents and tracers.

The substrate may be a proppant. While referring to the proppant or substrate it is important to note that any solid, such as gravel used in gravel pack operations, that is pumped downhole could be used with multiple coatings to carry chemicals downhole while minimizing chemical contamination of the carrying fluid. As such any reference to proppant includes gravel in gravel packs as well as any substrate that is pumped downhole.

### DETAILED DESCRIPTION

The description that follows includes exemplary apparatus, methods, techniques, or instruction sequences that embody techniques of the inventive subject matter. However, it is understood that the described embodiments may be practiced without these specific details.

This description provides for coating multiple chemicals onto a single grain of proppant or other substrate. Typically, for use in a hydrocarbon formation, the substrate is the proppant. Any process for coating a substrate with a chemical may be used.

Typically, after the well is bored but before it begins production the well is hydraulically fractured and then chemically treated to enhance the well's production capability. In order to fracture the well a production tubing is run into the well to allow access to a hydrocarbon producing zone. The production tubing is then sealed above and below the hydrocarbon producing zone by annular seals or packers between the production tubing and the walls of the wellbore. Fracturing fluid is then pumped down the production tubing and out of a port in the production tubing and into the hydrocarbon producing formation. Pressure is then applied to the fracturing fluid from the surface through the production tubing and into the hydrocarbon producing formation to fracture the rock and then to expand the cracks that are formed in the rock so that a gap is formed in the rock formation.

Proppant is added to the fracturing fluid. Proppant may be sand, walnut shells, ceramics, aluminum beads, or any other small material that has high compressive strength. As the fracturing fluid fractures and expands the rocks to form gaps, the fracturing fluid carries the proppant into the gaps. Once the operator determines that the hydrocarbon producing zone has been sufficiently fractured, the pressure from the surface is stopped. The gaps formed in the rock during the fracturing process would re-close but for the proppant, that was carried in by the fracturing fluid, propping open the formation.

In addition to adding proppant to the fracturing fluid other chemicals need to be added to the fracturing fluid, for example, to facilitate the fluid carrying the proppant into the hydrocarbon formation. In particular friction reducers, gelling agents, clay control systems, biocides, scale inhibitors, chelating agents, gel breakers, antifoamers, crosslinkers, wax inhibitors, anti-sludging agents, a corrosion inhibitors, de-emulsifiers, foaming agents, agglomerating agents and tracers may be useful in treating a well.

Typically large amounts of fluid are used to fracture a well. Consequently large amounts of chemicals may be used in the hydraulic fracturing process. By coating the chemicals onto the proppant the total amount of chemicals used may be reduced as the chemicals can be carried by the proppant to the place in the well where the chemicals are the most useful, into the gaps formed in the hydrocarbon formation by the hydraulic fracturing process. Such a reduction in the total amount of chemicals used reduces the cost of production and reduces the amount of chemically contaminated fluids produced from the well.

In order to efficiently utilize the proppant as a chemical carrier it is most efficient to have the grains of proppant coated with more than a single wellbore chemical each. When the grains of proppant each have a different single chemical coated thereon the various grains need to be mixed on the surface for an even distribution through the formation. Even when they are mixed on the surface the various types of proppant may segregate out from one another during the long journey from the surface to the formation. It is most efficient to have multiple chemical coatings on each grain of proppant. In those instances where the wellbore chemicals are not sufficiently adhesive on their own then the wellbore chemicals may be mixed with the adhesive without having a separate adhesive layer between the proppant and the wellbore chemical.

One well known coating process utilizes coating compositions that have good adhesion. Where a coating composition may be obtained by incorporating certain copolymers or cooligomers as adhesion promoters. These copolymers or cooligomers comprise monomer units derived from at least one acrylate or acrylamide monomers, an amine containing ethylenically unsaturated monomers, an ethylenically unsaturated associative monomer, and a polyacrylate of polyols. The amine sites of the copolymers or cooligomers are at least partially neutralized with acid prior to application of the coating formulation. The resulting coatings exhibit surprisingly good adhesion to organic and inorganic substrates which do not suffer any appreciable deterioration even after storage or exposure to sunlight.

Many different compounds that are used in downhole hydrocarbon production may be coated onto the proppant either by coating the material directly on the substrate or by combining the compound with an adhesive. In particular friction reducers, gelling agents, clay control systems, biocides, scale inhibitors, chelating agents, gel breakers, antifoamers, crosslinkers, wax inhibitors, anti-sludging agents, a corrosion inhibitors, de-emulsifiers, foaming agents, surfactants, agglomerating agents and tracers may be useful in treating a well.

Polyacrylamide and polyacrylate polymers and copolymers are used typically as friction reducers at low concentrations for all temperatures ranges.

Present preferred gelling agents include guar gums, hydroxypropyl guar, carboxymethyl hydroxypropyl guar, carboxymethyl guar, and carboxymethyl hydroxyethyl cellulose. Suitable hydratable polymers may also include synthetic polymers, such as polyvinyl alcohol, polyacrylamides, poly-2-amino-2-methyl propane sulfonic acid, and various other synthetic polymers and copolymers. Other examples of such polymer include, without limitation, guar gums, high-molecular weight polysaccharides composed of mannose and galactose sugars, or guar derivatives such as hydropropyl guar (HPG), carboxymethyl guar (CMG). carboxymethylhydropropyl guar (CMHPG), hydroxyethylcellulose (HEC), hydroxypropylcellulose (HPC), carboxymethylhydroxyethylcellulose (CMHEC), xanthan, scleroglucan, polyacrylamide, polyacrylate polymers and copolymers.

Clay control additives may include the use of flax seed gum and up to 10,000 ppm of potassium or ammonium cations, the use of an acid salt of alkaline esters, the use of aliphatic hydroxyacids with between 2-6 carbon atoms, the use of cationic allyl ammonium halide salts, the use of poly allyl ammonium halide salts, the use of polyols containing at least 1 nitrogen atom preferably from a diamine, the use of primary diamine salt with a chain length of 8 or less, the use of quaternized trihydroxyalkylamines or choline derivatives, and the use of quaternary amine-based cationic polyelectrolyte and salts. The cation of the salts may be a divalent salt cation, a choline cation, or certain N-substituted quaternary ammonium salt cations.

Any desired non-oxidating biocide including aldehydes, quaternary phosphonium compounds, quaternary ammonium surfactants, cationic polymers, organic bromides, metronidazole, isothiazolones, isothiazolinones, thiones, organic thiocyanates, phenolics, alkylamines, diamines, triamines, dithiocarbamates, 2-(decylthio)ethanamine (DTEA) and its hydrochloride, and triazine derivatives.

Any desired oxidating biocides including hypochlorite and hypobromite salts, stabilized bromine chloride, hydroxyl radicals, chloramines, chlorine dioxide, chloroisocyanurates, halogen-containing hydantoins, and hydrogen peroxide and peracetic acid.

Scale control additives including chelating agents, may be Na, K or NH₄⁺ salts of EDTA; Na, K or NH₄⁺ salts of NTA; Na, K or NH.sub.4.sup.+ salts of Erythorbic acid; Na, K or NH.sub.4.sup.+ salts of thioglycolic acid (TGA); Na, K or NH.sub.4.sup.+ salts of Hydroxy acetic acid; Na, K or NH.sub.4.sup.+ salts of Citric acid; Na, K or NH.sub.4.sup.+ salts of Tartaric acid or other similar salts or mixtures or combinations thereof. Suitable additives that work on threshold effects, sequestrants, include, without limitation: Phosphates, e.g., sodium hexamethylphosphate, linear phosphate salts, salts of polyphosphoric acid, Phosphonates, e.g., nonionic such as HEDP (hydroxythylidene diphosphoric acid), PBTC (phosphoisobutane, tricarboxylic acid), Amino phosphonates of: MEA (monoethanolamine), NH.sub.3, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P.sub.20.sub.5) esters of: alkanol amines such as MEA, DEA, triethanol amine (TEA), Bishydroxyethylethylene diamine; ethoxylated alcohols, glycerin, glycols such as EG (ethylene glycol), propylene glycol, butylene glycol, hexylene glycol, trimethylol propane, pentaeryithrol, neopentyl glycol or the like; Tris & Tetrahydroxy amines; ethoxylated alkyl phenols (limited use due to toxicity problems), Ethoxylated amines such as monoamines such as MDEA and higher amines from 2 to 24 carbons atoms, diamines 2 to 24 carbons carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

A suitable crosslinking agent can be any compound that increases the viscosity of the fluid by chemical crosslinking, physical crosslinking, or any other mechanisms. For example, the gellation of a hydratable polymer can be achieved by crosslinking the polymer with metal ions including boron, zirconium, and titanium containing compounds, or mixtures thereof. One class of suitable crosslinking agents are organotitanates. Another class of suitable crosslinking agents are borates.

Typically gel-breakers are either oxidants or enzymes which operate to degrade the polymeric gel structure. Most degradation or “breaking” is caused by oxidizing agents, such as persulfate salts (used either as is or encapsulated), chromous salts, organic peroxides or alkaline earth or zinc peroxide salts, or by enzymes.

Presently preferred corrosion inhibitors include, but are not limited to quaternary ammonium salts such as chloride, bromides, iodides, dimethylsulfates, diethylsulfates, nitrites, bicarbonates, carbonates, hydroxides, alkoxides, or the like, or mixtures or combinations thereof; salts of nitrogen bases; or mixtures or combinations thereof. Quaternary ammonium salts include, without limitation, quaternary ammonium salts from an amine and a quaternarization agent, such as, alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, such as, alkylpyridines, especially, highly alkylated alkylpyridines, alkyl quinolines, C6 to C24 synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Salts of nitrogen bases, include, without limitation, salts of nitrogen bases derived from a salt, such as: C1 to C8 monocarboxylic acids such as formic acid, acetic acid, propanoic acid, butanoic acid, pentanoic acid, hexanoic acid, heptanoic acid, octanoic acid, 2-ethylhexanoic acid, or the like; C2 to C12 dicarboxylic acids, C2 to C12 unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, such as: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

Options for controlling oxygen content includes: (1) de-aeration of the fluid prior to downhole injection, (2) addition of normal sulfides to product sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Examples include oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

Agglomeration Agents include organo siloxanes, amines comprises aniline and alkyl anilines or mixtures of alkyl anilines, pyridines and alkyl pyridines or mixtures of alkyl pyridines, pyrrole and alkyl pyrroles or mixtures of alkyl pyrroles, piperidine and alkyl piperidines or mixtures of alkyl piperidines, pyrrolidine and alkyl pyrrolidines or mixtures of alkyl pyrrolidines, indole and alkyl indoles or mixture of alkyl indoles, imidazole and alkyl imidazole or mixtures of alkyl imidazole, quinoline and alkyl quinoline or mixture of alkyl quinoline, isoquinoline and alkyl isoquinoline or mixture of alkyl isoquinoline, pyrazine and alkyl pyrazine or mixture of alkyl pyrazine, quinoxaline and alkyl quinoxaline or mixture of alkyl quinoxaline, acridine and alkyl acridine or mixture of alkyl acridine, pyrimidine and alkyl pyrimidine or mixture of alkyl pyrimidine, quinazoline and alkyl quinazoline or mixture of alkyl quinazoline, or mixtures or combinations thereof. Additionally, amines comprise polymers and copolymers of vinyl pyridine, vinyl substituted pyridine, vinyl pyrrole, vinyl substituted pyrroles, vinyl piperidine, vinyl substituted piperidines, vinyl pyrrolidine, vinyl substituted pyrrolidines, vinyl indole, vinyl substituted indoles,vinyl imidazole, vinyl substituted imidazole, vinyl quinoline, vinyl substituted quinoline, vinyl isoquinoline, vinyl substituted isoquinoline, vinyl pyrazine, vinyl substituted pyrazine, vinyl quinoxaline, vinyl substituted quinoxaline, vinyl acridine, vinyl substituted acridine, vinyl pyrimidine, vinyl substituted pyrimidine, vinyl quinazoline, vinyl substituted quinazoline, or mixtures and combinations thereof.

Foaming Agents include suitable sodium salts of alpha olefin sulfonates (AOSs), include, without limitation, any alpha olefin sulfonate. Preferred AOSs including short chain alpha olefin sulfonates having between about 2 and about 10 carbon atoms, particularly, between 4 and 10 carbon atoms, longer chain alpha olefin sulfonates having between about 10 and about 24 carbon atoms, particularly, between about 10 and 16 carbon atoms or mixtures or combinations thereof.

Suitable foam modifiers that can be used in place of or in conjunction with AOS include, cyclamic acid salts such as sodium (cyclamate), potassium, or the like, salts of sulfonated methyl esters having between about 12 and about 22 carbon atoms, where the salt is sodium, potassium, ammonium, alkylammonium, 2-aminoethanesulfonic acid (taurine) or the like such as Alpha-Step MC-48 from Stepan Corporation. Other additives includes salts of 2-aminoethane sulfonic acids, where the salt is an alkali metal, ammonium, alkylammonium, or like counterions.

Suitable fatty acids include, lauric acid, oleic acid, stearic acid or the like or mixtures or combinations.

Suitable foam enhancers include, a foam enhancer selected from the group consisting of a linear dodecyl benzene sulfonic acid salt, a sarcosinate salt, and mixtures or combinations thereof. Preferred linear dodecyl benzene sulfonic acid salt include, ammonium linear dodecyl benzene sulfonic acid, alkylammonium linear dodecyl benzene sulfonic acid, alkanolamine ammonium linear dodecyl benzene sulfonic acid, lithium linear dodecyl benzene sulfonic acid, sodium linear dodecyl benzene sulfonic acid, potassium, cesium linear dodecyl benzene sulfonic acid, calcium linear dodecyl benzene sulfonic acid, magnesium linear dodecyl benzene sulfonic acid and mixtures or combinations thereof. Preferred sarcosinates include, sodium lauryl sarcosinate, potassium lauryl sarcosinate, HAMPOSYL N-Acyl Sarcosinate Surfactants, Sodium N-Myristoyl Sarcosinate, and mixtures or combinations thereof.

Suitable additives for wax control include, cellosolves, cellosolve acetates, ketones, acetate and formate salts and esters, surfactants composed of ethoxylated or propoxylated alcohols, alkyl phenols, and/or amines, methylesters such as coconate, laurate, soyate or other naturally occurring methylesters of fatty acids; sulfonated methylesters such as sulfonated coconate, sulfonated laurate, sulfonated soyate or other sulfonated naturally occurring methyl esters of fatty acids; low molecular weight quaternary ammonium chlorides of coconut oils soy oils or C10 to C24 amines ormonohalogenated alkyl and aryl chlorides; quanternaryammonium salts composed of disubstituted (such as dicoco, etc.) and lower molecular weight halogenated alkyl and/or aryl chlorides, gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA), or other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids.

De-emulsifier's include soap, naphtenic acid salts and alkylaryl sulphonate, sulphated caster oil petroleum sulphonates, derivatives of sulpho-acid oxidized caster oil and sulphosucinic acid ester, fatty acids, fatty alcohols, alkylphenols, ethylene oxide, propylene oxide copolymer, alkoxylated cyclic p-alkylphenol formaldehyde resins, amine alkoxylate, alkoxylated cyclic p-alkylphenol formaldehyde resins, polyesteramine and blends. Also included are antifoamers wherein the major constituent would include no-polar oils, such as minerals and silicones or polar oils such as fatty alcohols, fatty acids, alkyl amines and alkyl amides.

The surfactants may be, for instance, silanes, siloxanes, fluorosurfactants, fluorinated surfactants, dihydroxyl alkyl glycinate, alkyl ampho acetate or propionate, alkyl betaine, alkyl amidopropyl betaine and alkylamino mono- or di-propionates derived from certain waxes, fats and oils. Including, amphoteric/zwitterionic surfactants, in particular those comprising a betaine moiety.

Tracers may be a dye, fluorescer or other chemical which can be detected using spectroscopic analytical methods such as UV-visible, fluorescence or phosphorescence. Compounds of lanthanide elements may be used as tracers because they have distinctive spectra. A tracer may be a chemical with distinctive features which enables it to be distinguished by another analytical technique such as GC-MS. Such chemicals include fluorocarbons and fluoro-substituted aromatic acids. Radio-isotopes may be used as tracers. Salts of ions which do not occur naturally in subterranean reservoirs, such as iodides and thiocyanates may also be used as a tracer.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A well treatment material comprising:
a substrate having two or more coatings without an intervening adhesive layer between the substrate and the first coating ;
wherein the substrate is suspended in a fluid, and wherein each coating is a material useful for treating a well.

2. The well treatment material of claim 1 wherein the substrate is a proppant.

3. The well treatment material of claim 2 wherein the proppant is a sand.

4. The well treatment material of claim 2 wherein the proppant is a natural occurring organic material.

5. The well treatment material of claim 2 wherein the proppant is a synthetic material.

6. The well treatment material of claim 1 wherein the materials useful for treating a wellbore are a friction reducer, a gelling agent, a clay control agent, a biocide, a scale inhibitor, a chelating agent, a gel-breaker, an oxygen scavenger, an antifoamer, a crosslinker, a wax inhibitor, a corrosion inhibitor, a de-emulsifier, a foaming agent, or a tracer.

7. The well treatment material of claim 1 wherein one of the materials useful for treating a wellbore is a friction reducer.

8. The well treatment material of claim 1 wherein one of the materials useful for treating a wellbore is a gelling agent.

9. The well treatment material of claim 1 wherein one of the materials useful for treating a wellbore is a clay control agent.

10. The well treatment material of claim 1 wherein one of the materials useful for treating a wellbore is a biocide.

11. The well treatment material of claim 1 wherein one of the materials useful for treating a wellbore is a scale inhibitor.

12. The well treatment material of claim 1 wherein one of the materials useful for treating a wellbore is a chelating agent.

13. The well treatment material of claim 1 wherein one of the materials useful for treating a wellbore is a gel-breaker.

14. The well treatment material of claim 1 wherein one of the materials useful for treating a wellbore is an antifoamer.

15. The well treatment material of claim 1 wherein one of the materials useful for treating a wellbore is a crosslinker.

16. The well treatment material of claim 1 wherein one of the materials useful for treating a wellbore is a wax inhibitor.

17. The well treatment material of claim 1 wherein one of the materials useful for treating a wellbore is a corrosion inhibitor.

18. The well treatment material of claim 1 wherein one of the materials useful for treating a wellbore is a de-emulsifier.

19. The well treatment material of claim 1 wherein one of the materials useful for treating a wellbore is a foaming agent.

20. The well treatment material of claim 1 wherein one of the materials useful for treating a wellbore is a tracer.

21. A method of making a well treatment material, comprising:
coating a substrate with a first coating comprising a first well treating agent and a second coating comprising a second well treating agent without an intervening adhesive layer between the substrate and the first coating.

22. The method of making a well treatment material of claim 21 wherein the substrate is suspended in a fluid.

23. The method of making a well treatment material of claim 21 wherein additional layers of a additional well treating agent are coated onto the substrate.

24. The method of making a well treatment material of claim 21 wherein the substrate is a proppant.

25. The method of making a well treatment material of claim 21 wherein the proppant is a sand.

26. The method of making a well treatment material of claim 21 wherein the proppant is a natural occurring organic material.

27. The method of making a well treatment material of claim 21 wherein the proppant is a synthetic material.

28. The method of making a well treatment material of claim 21 wherein the materials useful for treating a wellbore are a friction reducer, a gelling agent, a clay control agent, a biocide, a scale inhibitor, a chelating agent, a gel-breaker, an oxygen scavenger, a defoamer, a crosslinker, a wax inhibitor, an anti-sludging agent, a corrosion inhibitor, a de-emulsifier, a foaming agent, or a tracer.

29. The method of making a well treatment material of claim 21 wherein one of the materials useful for treating a wellbore is a friction reducer.

30. The method of making a well treatment material of claim 21 wherein one of the materials useful for treating a wellbore is a gelling agent.

31. The method of making a well treatment material of claim 21 wherein one of the materials useful for treating a wellbore is a surfactant

32. The method of making a well treatment material of claim 21 wherein one of the materials useful for treating a wellbore is a clay control agent.

33. The method of making a well treatment material of claim 21 wherein one of the materials useful for treating a wellbore is a biocide.

34. The method of making a well treatment material of claim 21 wherein one of the materials useful for treating a wellbore is a scale inhibitor.

35. The method of making a well treatment material of claim 21 wherein one of the materials useful for treating a wellbore is a chelating agent.

36. The method of making a well treatment material of claim 21 wherein one of the materials useful for treating a wellbore is a gel-breaker.

37. The method of making a well treatment material of claim 21 wherein one of the materials useful for treating a wellbore is an oxygen scavenger.

38. The method of making a well treatment material of claim 21 wherein one of the materials useful for treating a wellbore is a defoamer.

39. The method of making a well treatment material of claim 21 wherein one of the materials useful for treating a wellbore is a crosslinker.

40. The method of making a well treatment material of claim 21 wherein one of the materials useful for treating a wellbore is a wax inhibitor.

41. The method of making a well treatment material of claim 21 wherein one of the materials useful for treating a wellbore is an anti-sludging agent.

42. The method of making a well treatment material of claim 21 wherein one of the materials useful for treating a wellbore is a corrosion inhibitor.

43. The method of making a well treatment material of claim 21 wherein one of the materials useful for treating a wellbore is a de-emulsifier.

44. The method of making a well treatment material of claim 21 wherein one of the materials useful for treating a wellbore is a foaming agent.

45. The method of making a well treatment material of claim 21 wherein one of the materials useful for treating a wellbore is a tracer.
